(19) United States
(12) Patent Application Publication
(10) Pub. No.: US 2019/0147811 A1
(43) Pub. Date: May 16, 2019

(54) LIQUID CRYSTAL DISPLAY DEVICE, METHOD FOR DRIVING LIQUID CRYSTAL PANEL, AND METHOD FOR SETTING SIGNAL TO BE WRITTEN IN LIQUID CRYSTAL DISPLAY DEVICE

(71) Applicant: SHARP KABUSHIKI KAISHA, Sakai City, Osaka (JP)

(72) Inventor: Kazuko YOSHIDA, Sakai City (JP)

(73) Assignee: Sharp Kabushiki Kaisha, Sakai City, Osaka (JP)

(21) Appl. No.: 16/097,034

(22) PCT Filed: Apr. 26, 2017
(86) PCT No.: PCT/JP2017/016627

§ 371 Date: Oct. 26, 2018

(30) Foreign Application Priority Data
Apr. 28, 2016 (JP) 2016-091837

(51) Int. Cl. G09G 3/36

(52) U.S. Cl. CPC G09G 3/3607; G09G 2300/0452; G09G 2320/0271; G09G 2320/0247

(57) ABSTRACT

A liquid crystal display device that is able to efficiently reduce flashing is provided.

[Solution] In a case where a first pixel receives, in a preceding frame, first gradation data corresponding to a first gradation level, while receiving, in a current frame, second gradation data corresponding to a second gradation level, and a second pixel receives, in the preceding frame, the second gradation data corresponding to the second gradation level, while receiving, in the current frame, the first gradation data corresponding to the first gradation level, at least one of writing a signal corresponding to data obtained by correcting the second gradation data to the first pixel and writing a signal corresponding to data obtained by correcting the first gradation data to the second pixel is performed in the current frame, such that an amount of change of a summed luminance representing a sum of a luminance of the first pixel and a luminance of the second pixel toward the high luminance side relative to a sum of a first luminance and a second luminance is smaller than an amount of change of the summed luminance toward the low luminance side relative to the sum of the first luminance and the second luminance.

### TECHNICAL FIELD

The present invention relates to a liquid crystal display device.

### BACKGROUND ART

Liquid crystal display devices have response characteristics that differ depending on transition gradation levels. It is known that, for example, in a case where a liquid crystal panel in which a rise response from a gradation level of TL to a gradation level of TM (>TL) is faster than a decay response from the gradation level of TM to the gradation level of TL displays a checkered pattern, which has the gradation level of TL and the gradation level of TM, in a large size, when the checkered pattern is slowly moved (for example, one to several lines per second), a flashing phenomenon in which the entire screen flickers may be caused.

This is because, in a period during which the decay response from the gradation level of TM to the gradation level of TL (<TM) is unable to catch up with the rise response from the gradation level of TL to the gradation level of TM, a summed luminance representing a sum of a luminance of a pixel that undergoes the rise response from the gradation level of TL to the gradation level of TM and a luminance of a pixel that undergoes the decay response from the gradation level of TM to the gradation level of TL changes toward the high luminance side relative to a value of a steady state (a summed luminance obtained after the rise response catches up with the decay response).

### CITATION LIST

### Patent Literature

PTL 1: Japanese Unexamined Patent Application Publication (Translation of PCT Application) No. 2002-512386 (published on Apr. 23, 2002).

### SUMMARY OF INVENTION

### Technical Problem

PTL 1 discloses a method for performing multi-step signal conversion to make waveforms in the rise response and in the decay response symmetrical. There is, however, a problem of sufficient flashing-reduction effects not being obtained because of both an increase in a calculation amount for the signal conversion and the difficulty in determining a liquid crystal state in the preceding step.

One of the objects of the present invention is to provide a liquid crystal display device that is able to efficiently reduce the flashing.

### Solution to Problem

A liquid crystal display device according to the present invention includes a first pixel and a second pixel. With respect to each of the first pixel and the second pixel, a first luminance corresponding to a first gradation level is lower than a second luminance corresponding to a second gradation level. In a case where the first pixel receives, in the preceding frame, first gradation data corresponding to the first gradation level, while receiving, in the current frame, second gradation data corresponding to the second gradation level, and where the second pixel receives, in the preceding frame, the second gradation data corresponding to the second gradation level, while receiving, in the current frame, the first gradation data corresponding to the first gradation level, at least one of writing a signal corresponding to data obtained by correcting the second gradation data to the first pixel and writing a signal corresponding to data obtained by correcting the first gradation data to the second pixel is performed in the current frame such that an amount of change of a summed luminance representing a sum of a luminance of the first pixel and a luminance of the second pixel toward the high luminance side relative to a sum of the first luminance and the second luminance is smaller than an amount of change of the summed luminance toward the low luminance side relative to the sum of the first luminance and the second luminance.

### Advantageous Effects of Invention

According to the above configuration, the liquid crystal display device that is able to efficiently reduce the flashing is realized.

### BRIEF DESCRIPTION OF DRAWINGS

FIG. 1 is a block diagram illustrating a configuration of a liquid crystal display device.

FIG. 2 is a diagrammatic representation illustrating a display example on the liquid crystal display device.

FIG. 3 is a graph illustrating a change in a region luminance in FIG. 2.

FIG. 4 shows a table indicating a response time and a table indicating a difference between response times for each combination of the gradation level of the preceding frame and the gradation level of the current frame.

FIG. 5 shows a table indicating a flashing amplitude and a table indicating a percentage of luminance change for each combination of the gradation levels.

FIG. 6 shows a table indicating a visual status of flashing for each combination of the gradation levels.

FIG. 7 is a diagrammatic representation illustrating a method for setting a signal to be written.

FIG. 8 is an illustrative diagram illustrating a graph of the region luminance and a result in the correction example 1.

FIG. 9 is an illustrative diagram illustrating a graph of the region luminance and a result in the correction example 2.

FIG. 10 is an illustrative diagram illustrating a graph of the region luminance and a result in the correction example 3.

FIG. 11 is an illustrative diagram illustrating a graph of the region luminance and a result in the correction example 4.

FIG. 12 is an illustrative diagram illustrating a graph of the region luminance and a result in the correction example 5.

FIG. 13 is an illustrative diagram illustrating a graph of the region luminance and a result in the correction example 6.

FIG. 14 is an illustrative diagram illustrating a graph of the region luminance and a result in the correction example 7.

FIG. 15 is an illustrative diagram illustrating a graph of the region luminance and a result in the correction example 8.

FIG. 16 is an illustrative diagram illustrating a graph of the region luminance and a result in a case without correction.

### DESCRIPTION OF EMBODIMENTS

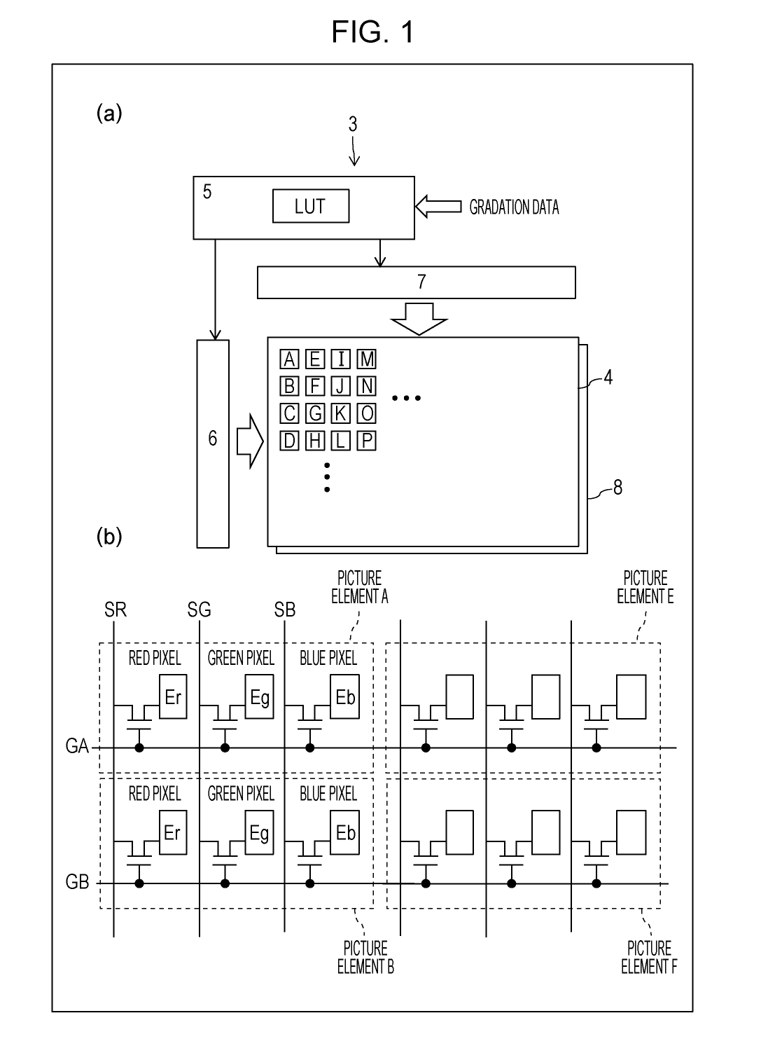

Embodiments of the invention will be described hereinafter with reference to FIGS. 1 to 16.

FIG. 1 is a block diagram illustrating a configuration of a liquid crystal display device. As illustrated in FIG. 1, a liquid crystal display device 3 includes a liquid crystal panel 4, a control circuit 5, a gate driver 6, a source driver 7, and a backlight 8. The gate driver 6 drives scan signal lines of the liquid crystal panel 4. The source driver 7 drives data signal lines of the liquid crystal panel 4. The backlight 8 illuminates the back surface of the liquid crystal panel 4 with light. The control circuit 5 receives image data (gradation data) from the outside and controls the gate driver 6 and the source driver 7.

A plurality of picture elements are arrayed in a matrix on the liquid crystal panel 4. In FIG. 1(a), picture elements A to D are disposed in the first column, picture elements E to H are disposed in the second column, picture elements I to L are disposed in the third column, and picture elements M to P are disposed in the fourth column. Pixels A, E, I, and M are disposed in the first row, pixels B, F, J, and N are disposed in the second row, pixels C, G, K, and O are disposed in the third row, and pixels D, H, L, and P are disposed in the fourth row.

As illustrated in FIG. 1(b), each picture element includes a red pixel, a blue pixel, and a green pixel. The red pixel includes a pixel electrode Er. The green pixel includes a pixel electrode Eg. The blue pixel includes a pixel electrode Eb. Note that liquid crystal capacitors are formed between the pixel electrodes Er, Eg, and Eb and a counter electrode (not illustrated). In some case, the counter electrode is formed on the same substrate as the pixel electrodes. In other cases, the counter electrode may be formed on a different substrate from that of the pixel electrodes.

For example, the picture element A includes the pixel electrode Er that is coupled to a data signal line SR and a scan signal line GA through a transistor, the pixel electrode Eg that is coupled to a data signal line SG and the scan signal line GA through a transistor, and the pixel electrode Eb that is coupled to a data signal line SB and the scan signal line GA through a transistor.

In a case where a signal is written to each of the pixels, first, a signal for switching transistors on is input to the scan signal line GA, which corresponds to pixels in the first row, and signals are written to the pixels in the first row through the transistors from data signal lines. Next, after a signal for switching the transistors off is input to the scan signal line GA, a signal for switching transistors on is input to a scan signal line GB, which corresponds to pixels in the next row (the second row), and signals are written to the pixels in the second row through the transistors from the data signal lines. This process is performed repeatedly up to the final row.

A single frame period is a period from the moment when writing signals to pixels in the first row is performed to the moment when writing signals to the pixels in the first row is performed again. Writing a signal to each pixel is performed once in the single frame period. In a case of liquid crystal display devices, the writing to each pixel is performed, for example, 10 to 240 times or so per second (driving at 10 Hz to 240 Hz). In driving at 60 Hz, the length of the single frame period (equal to one vertical scanning period) is 1 (second)/60% 16.7 milliseconds. In addition, a writing period for one pixel (one horizontal scanning period) is equal to or shorter than a length obtained by dividing the length of one frame by the number of the scan signal lines. For example, in a case where the number of the scan signal lines is 1000, the writing period for one pixel is approximately 16.7 microseconds.

The control circuit 5 includes a lookup table (LUT) and inputs writing gradation data to the source driver 7, the writing gradation data being obtained by correcting the image data (the gradation data) received from the outside by using the LUT as appropriate. The source driver 7 generates a signal (an analog potential signal) based on the writing gradation data from the control circuit 5 and writes the signal to a pixel through a data signal line and a transistor.

When a pixel is caused to transition from luminance X to luminance Y, while another pixel of the same color is caused to transition from luminance Y to luminance X, the transition time of the luminance and/or the manner of a change in the luminance during the transition period may differ in some case. This arises from a difference in response speed of liquid crystal molecules. In a case where the liquid crystal molecules are caused to transition from some alignment state to another alignment state, a response speed depends on each of the alignment states before and after the transition. The response speed is known to be a few milliseconds to 100 milliseconds or so under conditions typically employed in liquid crystal panels with respect to a liquid crystal material, the distance between electrodes, and the like. In this embodiment, when a pixel is caused to transition from luminance X to luminance Y, while another pixel of the same color is caused to transition from luminance Y to luminance X, a signal (the potential signal) that corresponds to data obtained by correcting gradation data is written to at least one of the two pixels in only one frame (namely a period having a length of approximately 16.7 milliseconds for driving at 60 Hz) such that an amount of change of a summed luminance representing a sum of a luminance of the pixel and a luminance of the other pixel in the transition period toward the high luminance side relative to a sum of the luminance X and the luminance Y (a summed luminance obtained before or after the transition) is smaller than an amount of change toward the low luminance side, preferably such that the amount of change toward the high luminance side is zero, more preferably such that the amount of change toward the low luminance side is smaller than 30% of the sum of the luminance X and the luminance Y.

For example, suppose the following: an input gradation level can be any one of a 0th gradation level to a 255th gradation level; a gradation level corresponding to luminance X is the 0th gradation level; and a gradation level corresponding to luminance Y is a 47th gradation level. To a pixel that undergoes a transition from luminance X to luminance Y (>X), in other words, a rise-type response from a dark state to a bright state, a potential signal V72 corresponding to gradation data T72 for a 72nd gradation level is written only when the change occurs (in a single frame), the gradation data T72 being obtained by correcting gradation data T47 for the 47th gradation level. On the other hand, to a pixel that undergoes a transition from luminance Y to luminance X (a decay-type response), a potential signal V8 corresponding to gradation data T8 for an eighth gradation level is written only when the change occurs (in a single frame), the gradation data T8 being obtained by correcting gradation data T0 for the 0th gradation level. In a case where there is no difference in the gradation data between the preceding frame and the current frame, no correction is made, and a signal corresponding to gradation data of the current frame is written.

The writing gradation data based on the combination of the gradation data for the preceding frame and the gradation data for the current frame (gradation transitions) is described in the LUT of the control circuit 5.

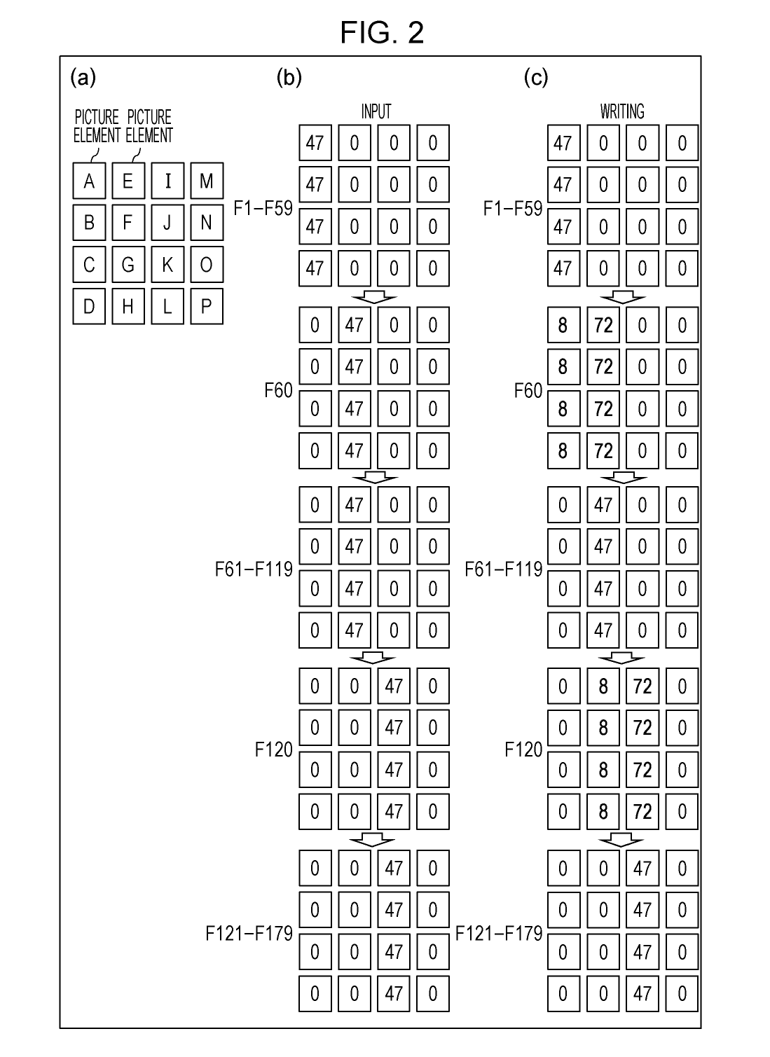

FIG. 2 illustrates a case where, in a region (FIG. 2(a)) including the picture elements A to P illustrated in FIG. 1(a), a vertical line having luminance Y is displayed on a background having luminance X while the vertical line is moved from the left to the right in the figure. The speed of the vertical line (a picture-element line) movement is one column per second and writing to each pixel is performed 60 times per second (driving at 60 Hz). In addition, though three pixel electrodes (red, green, and blue) are included in each of the picture elements A to P (refer to FIG. 1(b)), signals corresponding to the same gradation data are written to three pixels in the same picture element.

In performing such displaying, as illustrated in FIG. 2(b), in frames F1 to F59, gradation data T47 for a 47th gradation level is input to pixels included in the picture elements A to D in the first column, and gradation data T0 for a 0th gradation level is input to pixels included in the picture elements E to P in the second, third, and fourth columns. In frames F60 to F119, the gradation data T0 for the 0th gradation level is input to the pixels included in the picture elements A to D in the first column, the gradation data T47 for the 47th gradation level is input to pixels included in the picture elements E to H in the second column, and the gradation data T0 for the 0th gradation level is input to pixels included in the picture elements I to P in the third and fourth columns. In frames F120 to F179, the gradation data T0 for the 0th gradation level is input to pixels included in the picture elements A to H in the first and second columns, the gradation data T47 for the 47th gradation level is input to pixels included in the picture elements I to L in the third column, and the gradation data T0 for the 0th gradation level is input to pixels included in the picture elements M to P in the fourth column.

In accordance with the input of the gradation data described above, in this embodiment, as illustrated in FIG. 2(c), in the frames F1 to F59, the signal V47 corresponding to the gradation data T47 is written to the pixels included in the picture elements A to D in the first column, and the signal V0 corresponding to the gradation data T0 is written to the pixels included in the picture elements E to P in the second, third, and fourth columns. In the frame F60, the signal V8 that corresponds to data obtained by correcting the signal V0 corresponding to the gradation data T0 is written to the pixels included in the picture elements A to D in the first column, the signal V72 that corresponds to data obtained by correcting the gradation data T47 is written to the pixels included in the picture elements E to H in the second column, and the signal V0 corresponding to the gradation data T0 is written to the pixels included in the picture elements I to P in the third and fourth columns. In the frames F61 to F119, the signal V0 corresponding to the gradation data T0 is written to the pixels included in the picture elements A to D in the first column, the signal V47 corresponding to the gradation data T47 is written to the pixels included in the picture elements E to H in the second column, and the signal V0 corresponding to the gradation data T0 is written to the pixels included in the picture elements I to P in the third and fourth columns. In the frame F120, the signal V0 corresponding to the gradation data T0 is written to the pixels included in the picture elements A to D in the first column, the signal V8 that corresponds to data obtained by correcting the gradation data T0 is written to the pixels included in the picture elements E to H in the second column, the signal V72 that corresponds to data obtained by correcting the gradation data T47 is written to the pixels included in the picture elements I to L in the third column, and the signal V0 corresponding to the gradation data T0 is written to the pixels included in the picture elements M to P in the fourth column. In the frames F121 to F179, the signal V0 corresponding to the gradation data T0 is written to the pixels included in the picture elements A to H in the first and second columns, the signal V47 corresponding to the gradation data T47 is written to the pixels included in the picture elements I to L in the third column, and the signal V0 corresponding to the gradation data T0 is written to the pixels included in the picture elements M to P in the fourth column.

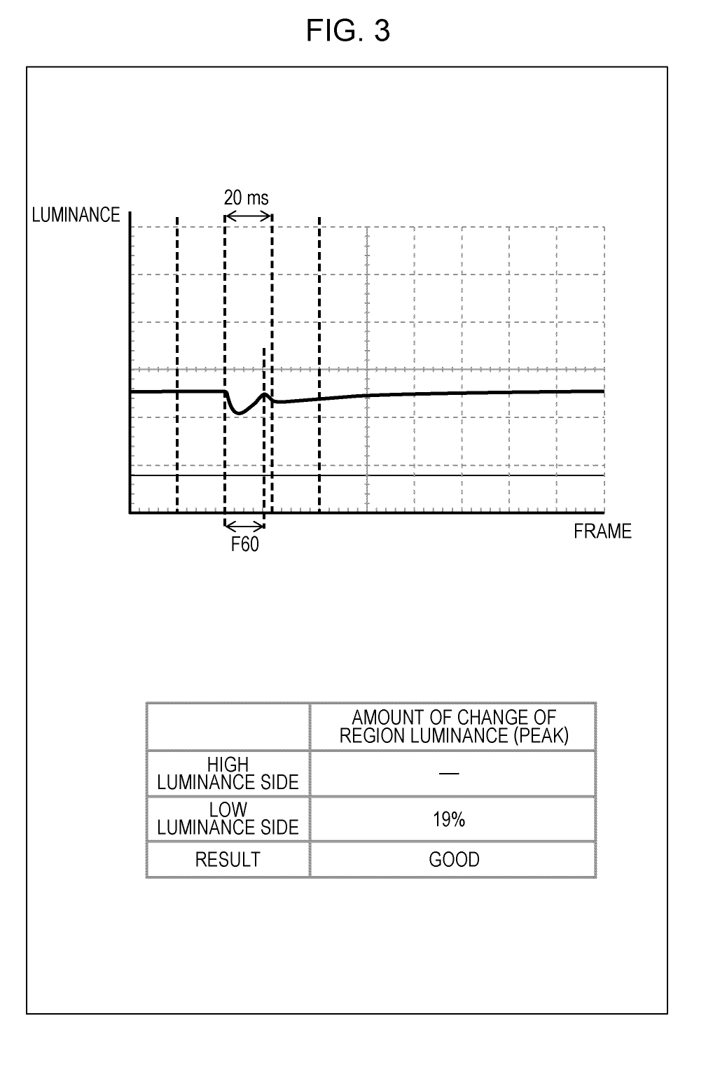

FIG. 3(a) illustrates the luminance of a region composed of the picture elements A, B, E, and F in a period including the frame F60 and several frames before and after the frame F60. FIG. 3 shows that insertion of the frame 60 (a frame in which signals corresponding to data obtained by correcting gradation data are written) and/or the frame F120 suppresses a change in a region luminance during the transition toward the high luminance side relative to a region luminance obtained before or after the transition (a region luminance reference value) and also limits the amount of change toward the low luminance side to 19% of the region luminance reference value, causing flashing to be less noticeable.

Note that, focusing on each pixel, the insertion of the frame 60 and/or the frame F120 suppresses a change in a summed luminance representing a sum of a luminance of a pixel (for example, a red pixel) included in the picture element A and a luminance of a pixel of the same color (for example, a red pixel) included in the picture element E during the transition toward the high luminance side relative to a sum of a pixel luminance corresponding to the 0th gradation level and a pixel luminance corresponding to the 47th gradation level (a summed-luminance reference value) and also limits the amount of change toward the low luminance side to 19% of the summed-luminance reference value.

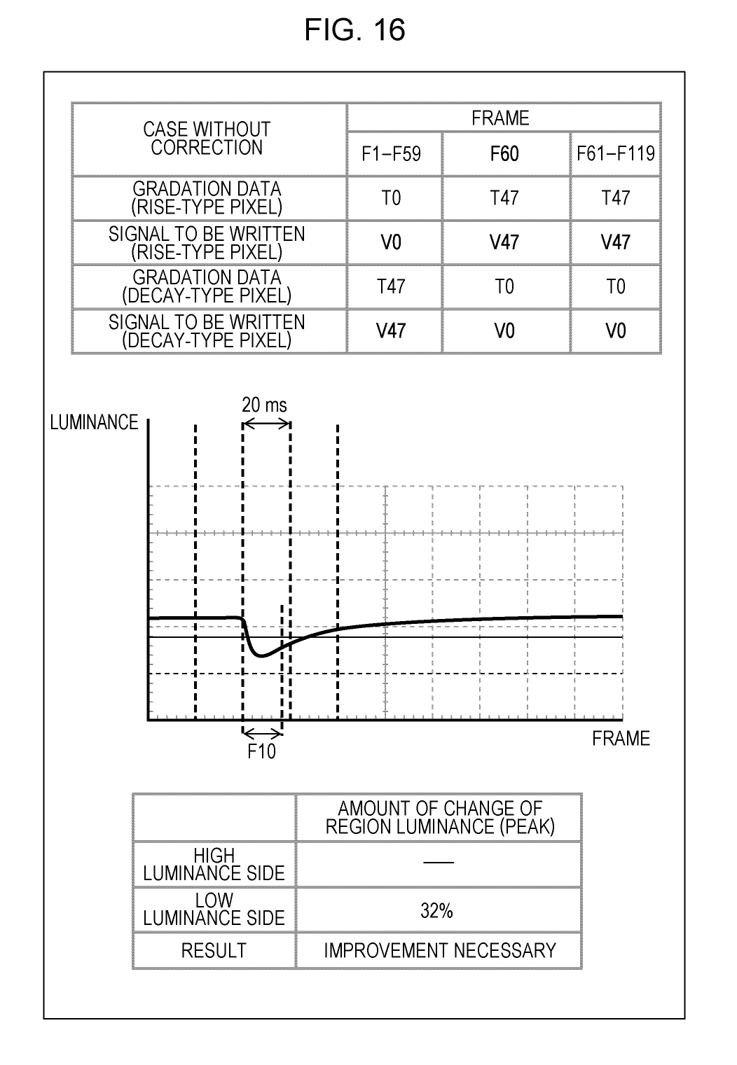

FIG. 16 illustrates a case where no correction is made to the gradation data (for example, the frame F60 is not inserted). It can be understood that, in this case, the amount of change of the region luminance in the transition exceeds 30% of the region luminance reference value and that the flashing is noticeable.

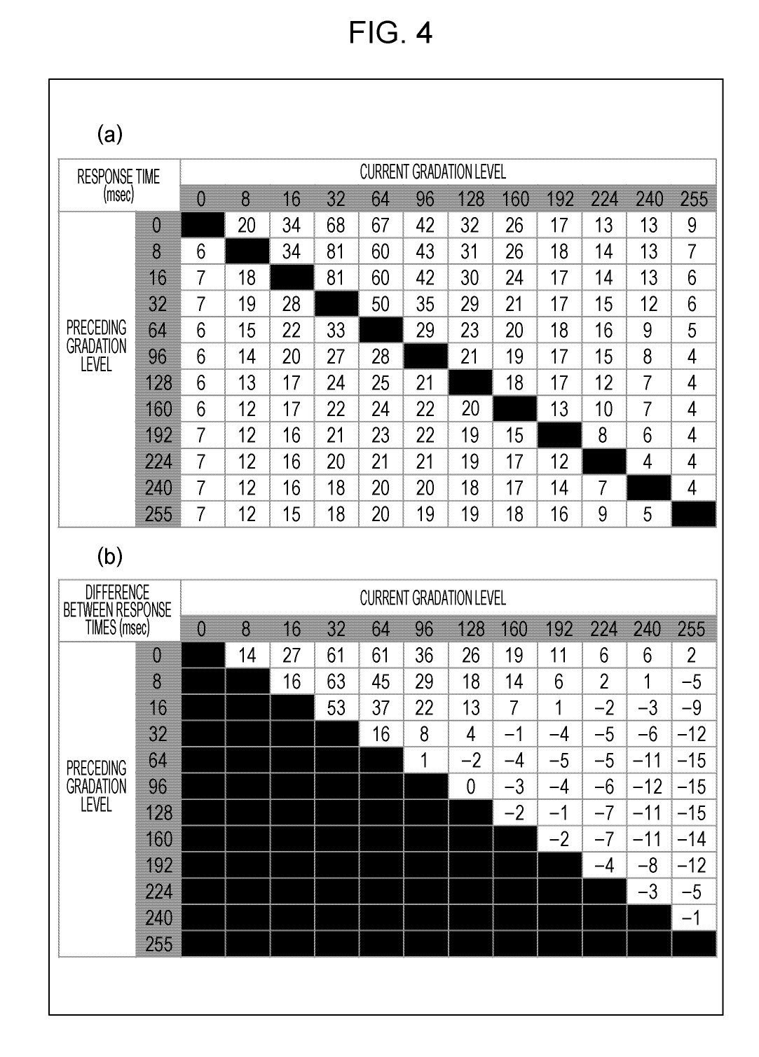

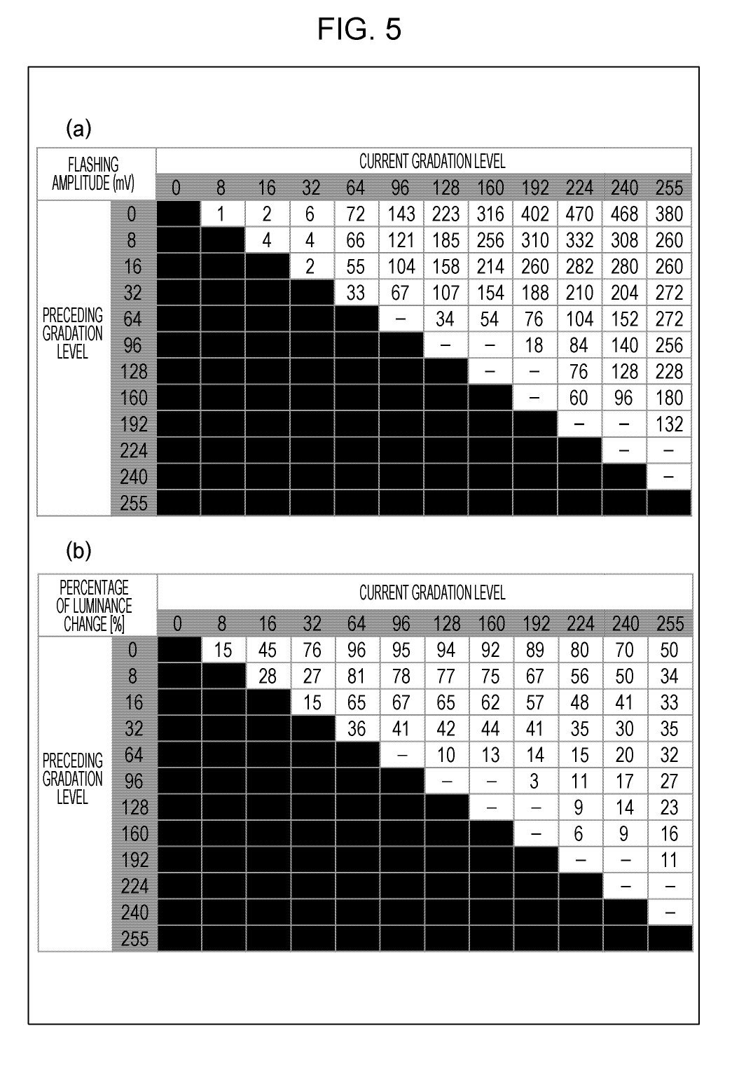

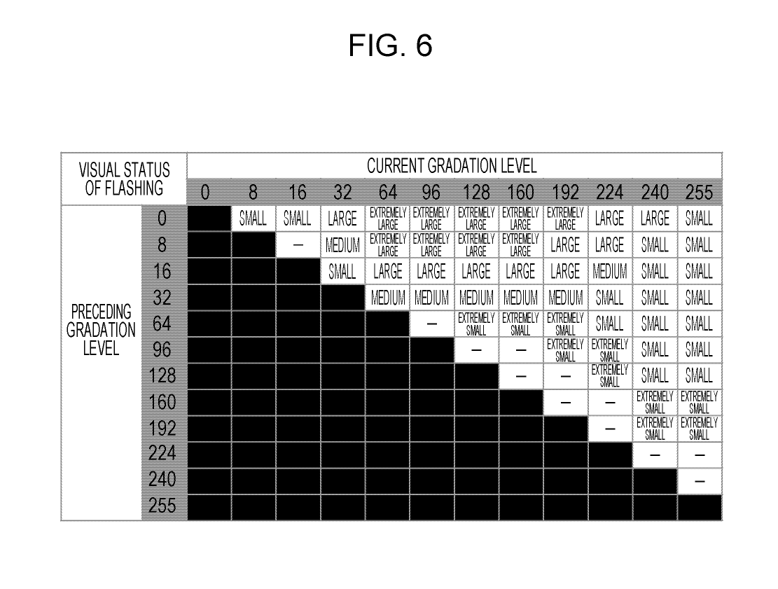

A method for generating the LUT for correcting the gradation data will be described hereinafter. FIG. 4 shows a table indicating a response time and a table indicating a difference between response times for each combination of the gradation level of the preceding frame and the gradation level of the current frame. FIG. 5 shows a table indicating a flashing amplitude and a table indicating a percentage of luminance change for each combination of the gradation levels. FIG. 6 shows a table indicating a visual status of the flashing corresponding to each combination of the gradation levels.

The response time is defined here as a time difference between the moment when a luminance change corresponding to 10% of a difference between a luminance before the transition and a luminance after the transition is achieved and the moment when a luminance change corresponding to 90% thereof is achieved. This is determined for reducing a variation in response time due to measurement errors in the luminance. However, without any limitation to this definition, other values such as luminance changes corresponding to 5% and 95% may be used.

In addition, the flashing amplitude is a value (mV) obtained by measuring a difference between the maximum luminance and the minimum luminance in the transition period by using a photodiode (for example, a photodiode S9219, commercially available from Hamamatsu Photonics K.K.) and an amplifier. The flashing amplitude can be obtained by measuring a region luminance when darkness and brightness in a display area for a checkered pattern are reversed (to be described later). Although a condition is set in which the writing to each pixel is performed 60 times per second (driving at 60 Hz), it is preferable to set the frequency of the writing in accordance with a driving frequency of the liquid crystal panel.

It should be noted that the percentage of luminance change corresponds to a ratio of the amplitude of the flashing to the region luminance obtained before or after the transition (the region luminance reference value).

FIGS. 4 to 6 show that the flashing is large for a combination of any gradation level that is near to the minimum gradation level (the 0th gradation level) and any gradation level in a medium gradation region (in particular, the 64th to 192nd gradation levels). Specifically, taking FIGS. 4 to 6 into account, combinations of gradation levels to which the correction should be made are determined.

In the following, an explanation will be made of a case where appropriate corrections for, as an example, a combination of a 0th gradation level and a 47th gradation level are obtained.

In this aspect, it is possible to make adjustments such that the flashing occurs toward the high luminance side as a result of the correction. In general, however, flashing on the high luminance side is visibly more detectable than flashing on the low luminance side. Accordingly, regarding the region luminance, an amount of change relative to the region luminance obtained before or after the transition (the region luminance reference value) is decreased on the high luminance side compared with on the low luminance side. Specifically, an amount of change toward the low luminance side relative to the region luminance reference value is decreased to less than 30% of the region luminance reference value, and an amount of change toward the high luminance side is decreased to less than 15% of the region luminance reference value.

It is more preferable to cause the amount of change toward the low luminance side relative to the region luminance reference value to be less than 30% of the region luminance reference value while ensuring that the region luminance does not exceed the region luminance reference value (no change toward the high luminance side).

The quality of the flashing depends not only on the amplitude of the luminance change (a difference in luminance) but also on duration. Accordingly, visual examination of the quality is also evaluated.

Focusing on each pixel, regarding the summed luminance representing a sum of a luminance of a rise-type responding pixel and a luminance of a decay-type responding pixel, an amount of change relative to a sum of a pixel luminance corresponding to one of two gradation levels and the pixel luminance corresponding to the other thereof (the summed-luminance reference value) is decreased on the high luminance side compared with on the low luminance side. Specifically, an amount of change toward the low luminance side relative to the summed-luminance reference value is decreased to less than 30% of the summed-luminance reference value, and an amount of change toward the high luminance side is decreased to less than 15% of the summed-luminance reference value. It is more preferable to cause the amount of change toward the low luminance side relative to the summed-luminance reference value to be less than 30% of the summed-luminance reference value while ensuring that the summed luminance does not exceed the summed-luminance reference value, (no change toward the high luminance side).

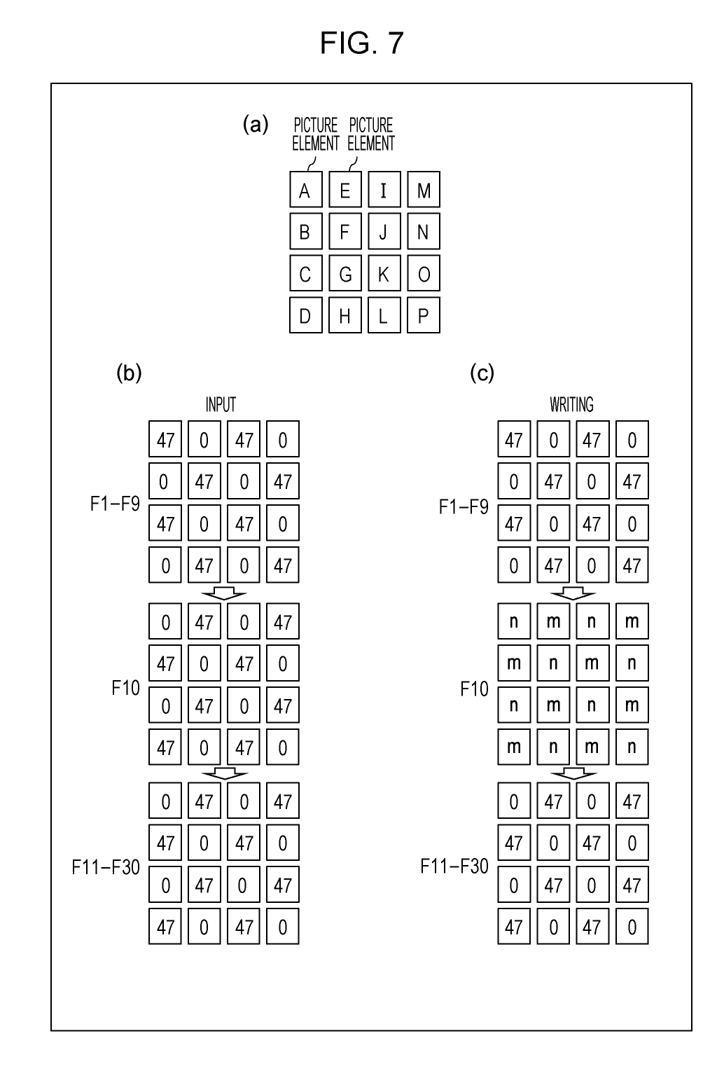

In a case where corrections for the combination of the gradation level of 0 and the gradation level of 47 are made, gradation data illustrated in FIG. 7(b) is input to the picture elements A to P illustrated in FIG. 7(a), writing illustrated in FIG. 7(c) is performed, and the amount of luminance change in a region composed of the picture elements A to P is then measured. Note that the reason for this is as follows: as illustrated in FIG. 7, setting the size of the checkered pattern to a single picture element as a unit causes both picture elements each including three rise-type responding pixels, which undergo a luminance transition from the dark state to the bright state, and picture elements each including three decay-type responding pixels, which undergo a luminance transition from the bright state to the dark state, to be uniformly distributed in the same number across the entire screen; and as a result, detection of the flashing (the luminance change) is facilitated. The size of the checkered pattern may be set to a single pixel as a unit.

In FIG. 7(c), in the frames F1 to F9, the signal V47 corresponding to gradation data T47 is written to pixels included in the picture elements A, I, F, N, C, K, H, and P, and the signal V0 corresponding to gradation data T0 is written to pixels included in the picture elements E, M, B, J, G, O, D, and L. In the frame F10, the signal Vn that corresponds to one of gradation data of the frame F10 and corrected data Tn therefor is written to the pixels included in the picture elements A, I, F, N, C, K, H, and P, and the signal Vm that corresponds to one of the gradation data of the frame F10 and corrected data Tm therefor is written to the pixels included in the picture elements E, M, B, J, G, O, D, and L. In the frames F11 to F30, the signal V0 corresponding to the gradation data T0 is written to the pixels included in the picture elements A, I, F, N, C, K, H, and P, and the signal V47 corresponding to the gradation data T47 is written to the pixels included in the picture elements E, M, B, J, G, O, D, and L. In a case where there is no difference in the gradation data between the preceding frame and the current frame, no correction is made, and a signal corresponding to gradation data of the current frame is written. It should be noted that the number of frames F1 to F9 and/or the number of frames F11 to F30 in FIG. 7 may be decreased or increased on the basis of a change in the region luminance or measurement errors.

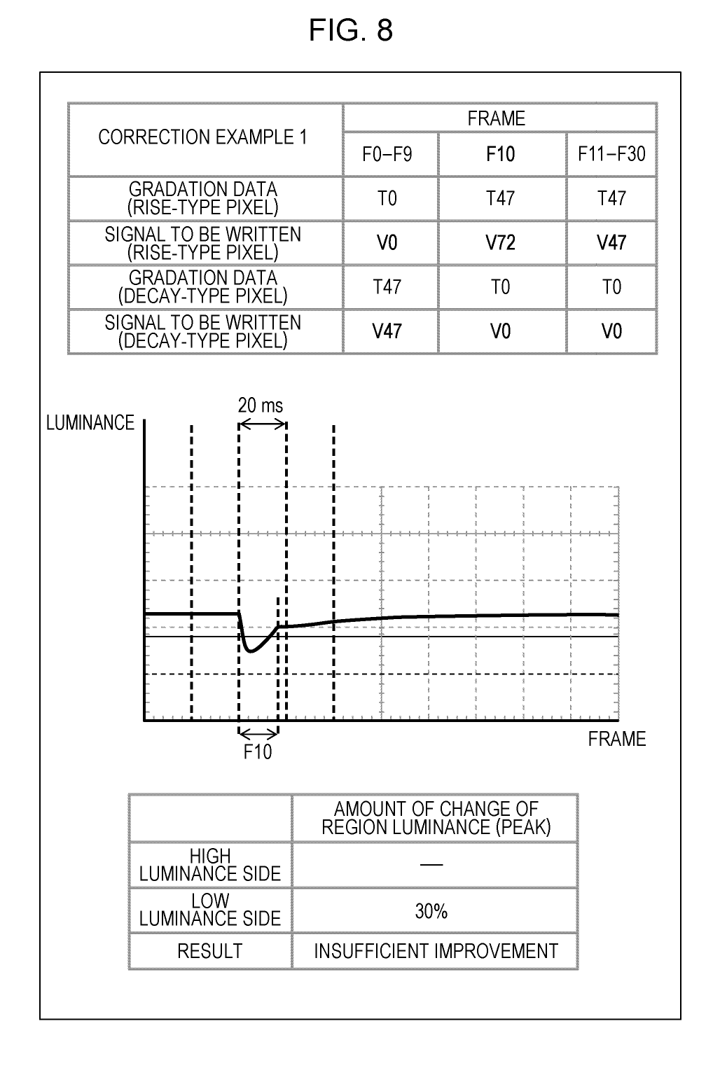

FIG. 8 illustrates a case that satisfies the following in FIG. 7(c): n=0 (without correction); m=72 (with correction); the signal V72 corresponding to data for a 72nd gradation level is written to rise-type pixels transitioning from the 0th gradation level to the 47th gradation level, the data having been obtained by correcting the gradation data T47 for the 47th gradation level; and the signal V0 corresponding to T0 is written to decay-type pixels transitioning from the 47th gradation level to the 0th gradation level, without any correction for the gradation data T0 for the 0th gradation level.

In this case, an amount of change toward the low luminance side is 30% and smaller than the amount of change (32%, refer to FIG. 16) obtained in the case where no correction is made. Also in the visual examination of display quality, the flashing is improved. The degree of the improvement, however, is insufficient.

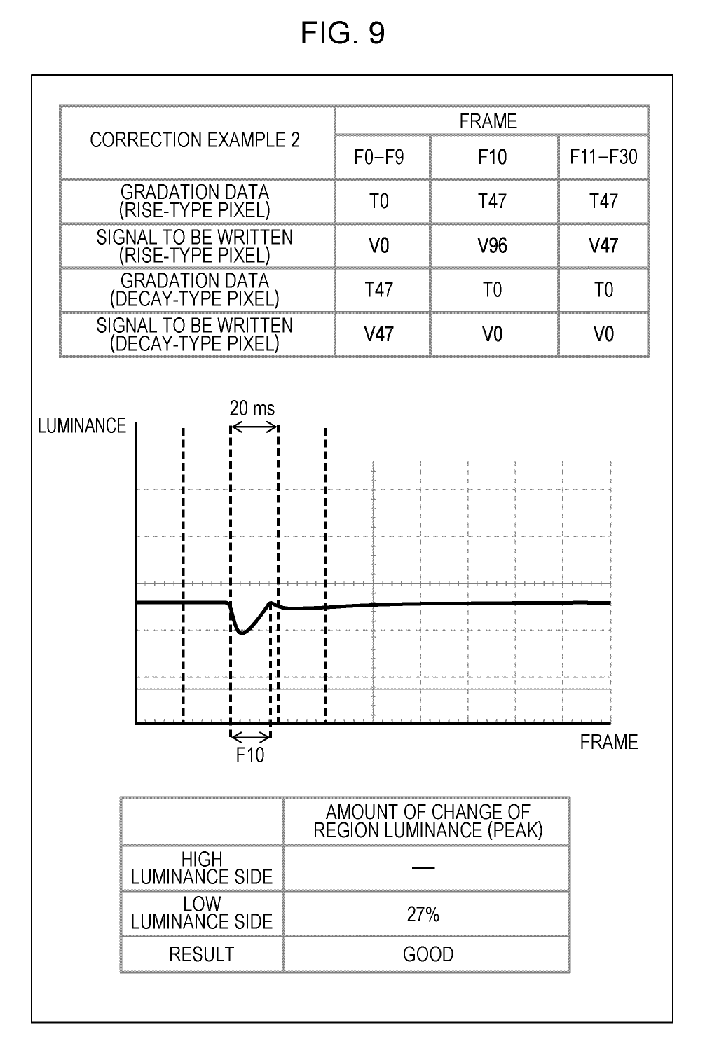

FIG. 9 illustrates a case that satisfies the following in FIG. 7(c): n=0 (without correction); m=96 (with correction); the signal V96 corresponding to data for a 96th gradation level is written to the rise-type pixels transitioning from the 0th gradation level to the 47th gradation level, the data having been obtained by correcting the gradation data T47 for the 47th gradation level; and the signal V0 corresponding to T0 is written to the decay-type pixels transitioning from the 47th gradation level to the 0th gradation level, without any correction for the gradation data T0 for the 0th gradation level.

In this case, an amount of change toward the low luminance side is 27%. Also in the visual examination of the display quality, the flashing is sufficiently improved. Accordingly, the result is determined to be good.

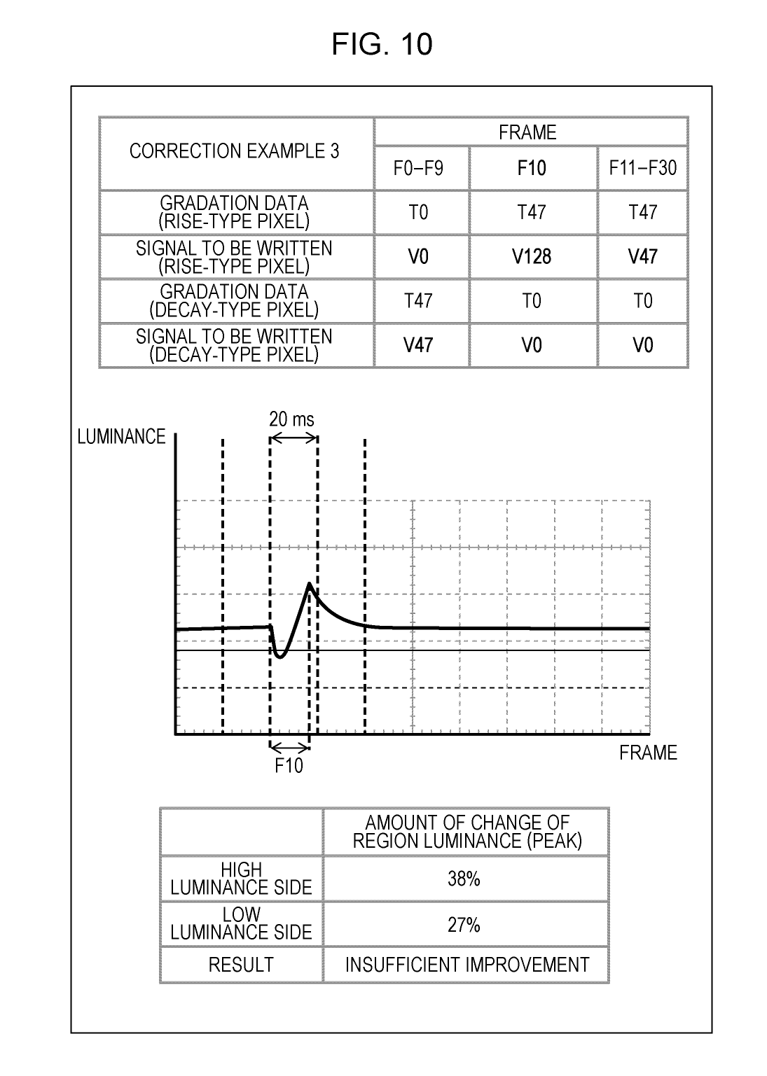

FIG. 10 illustrates a case that satisfies the following in FIG. 7(c): n=0 (without correction); m=128 (with correction); the signal V128 corresponding to data for a 128th gradation level is written to the rise-type pixels transitioning from the 0th gradation level to the 47th gradation level, the data having been obtained by correcting the gradation data T47 for the 47th gradation level; and the signal V0 corresponding to T0 is written to the decay-type pixels transitioning from the 47th gradation level to the 0th gradation level, without any correction for the gradation data T0 for the 0th gradation level. In this case, an amount of change toward the low luminance side is 27%, but, in the visual examination of the display quality, the flashing is not improved. In particular, visually detected is that a white screen appears to be inserted in the transition. Accordingly, the result is determined to be poor. This results from the following: adjustments to rates of luminance change in the rise-type pixels and in the decay-type pixels are inappropriate; and an amount of change toward the high luminance side is 38%.

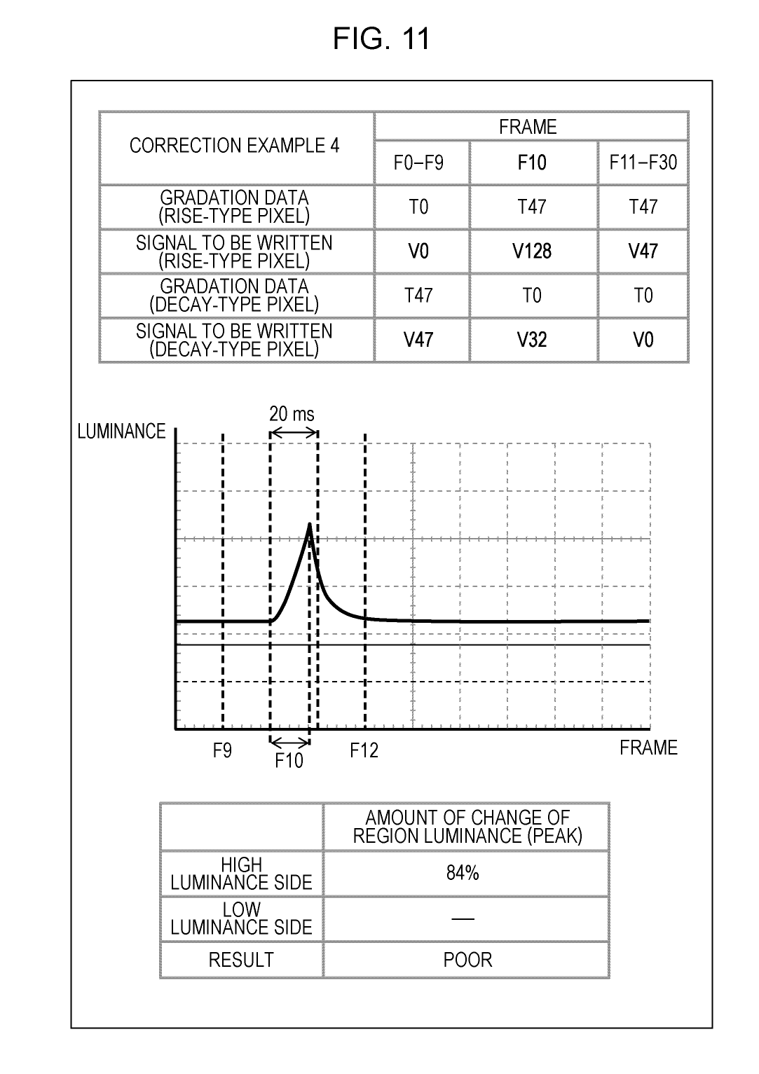

FIG. 11 illustrates a case that satisfies the following in FIG. 7(c): n=32 (with correction); m=128 (with correction); the signal V128 corresponding to data for a 128th gradation level is written to the rise-type pixels transitioning from the 0th gradation level to the 47th gradation level, the data having been obtained by correcting the gradation data T47 for the 47th gradation level; and the signal V32 corresponding to data for a 32nd gradation level is written to the decay-type pixels transitioning from the 47th gradation level to the 0th gradation level, the data having been obtained by correcting the gradation data T0 for the 0th gradation level.

In this case, though an amount of change toward the low luminance side is removed, the adjustments to the rates of luminance change are inappropriate and an amount of change toward the high luminance side is 84%. Also in the visual examination of the display quality, the flashing is not improved. In particular, visually detected is that a white screen appears to be inserted in the transition. Accordingly, the result is determined to be poor.

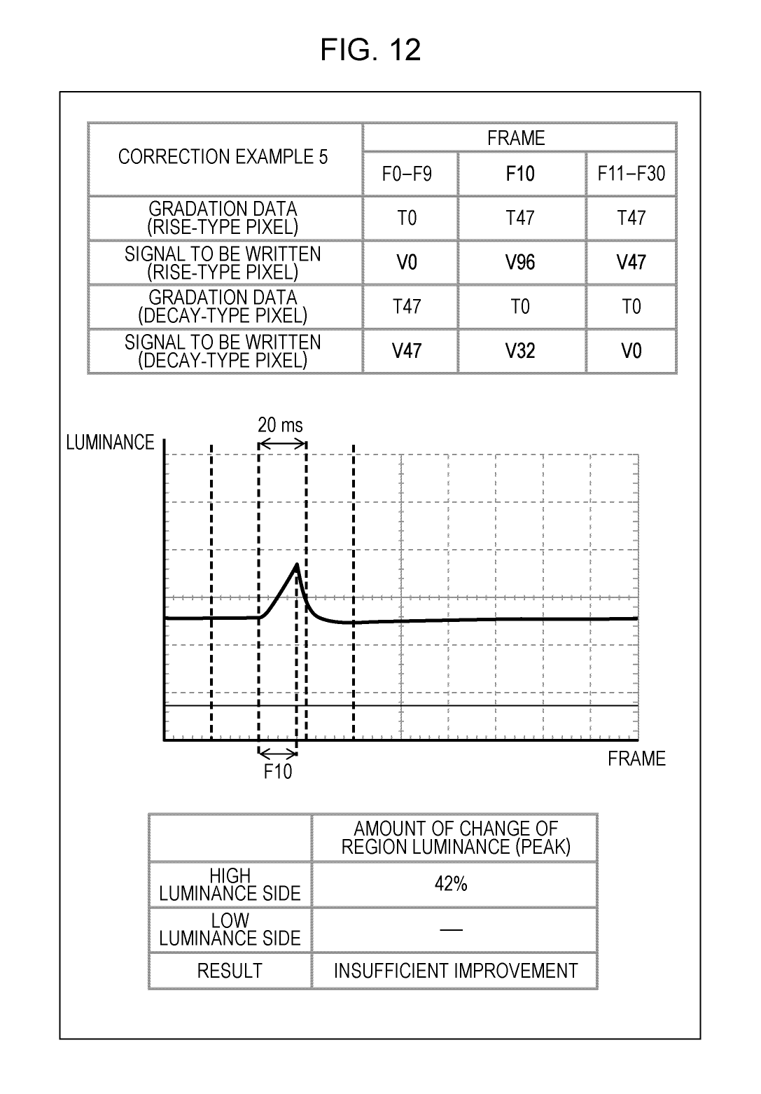

FIG. 12 illustrates a case that satisfies the following in FIG. 7(c): n=32 (with correction); m=96 (with correction); the signal V96 corresponding to data for a 96th gradation level is written to the rise-type pixels transitioning from the 0th gradation level to the 47th gradation level, the data having been obtained by correcting the gradation data T47 for the 47th gradation level; and the signal V32 corresponding to data for a 32nd gradation level is written to the decay-type pixels transitioning from the 47th gradation level to the 0th gradation level, the data having been obtained by correcting the gradation data T0 for the 0th gradation level. In this case, an amount of change toward the low luminance side is removed as in FIG. 11, and an amount of change toward the high luminance side is decreased to 42%. However, in the visual examination of the display quality, the flashing is not improved. In particular, visually detected is that a white screen appears to be inserted in a period between before the transition and after the transition. Accordingly, the result is determined to be poor.

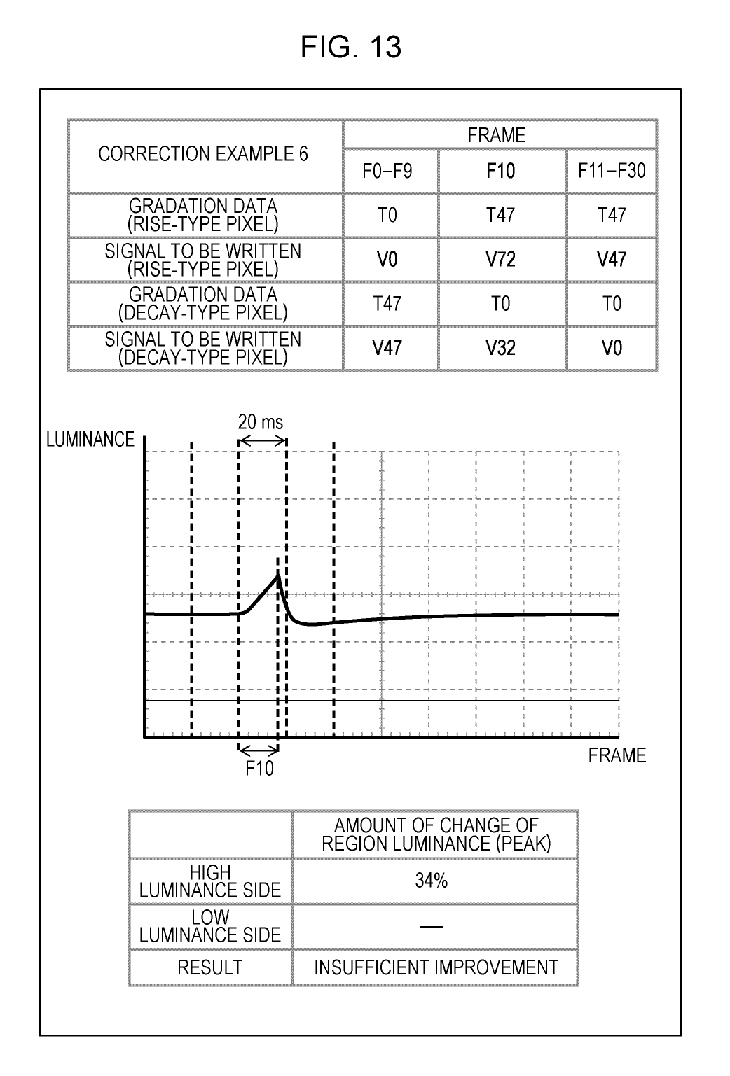

FIG. 13 illustrates a case that satisfies the following in FIG. 7(c): n=32 (with correction); m=72 (with correction); the signal V72 corresponding to data for a 72nd gradation level is written to the rise-type pixels transitioning from the 0th gradation level to the 47th gradation level, the data having been obtained by correcting the gradation data T47 for the 47th gradation level; and the signal V32 corresponding to data for a 32nd gradation level is written to the decay-type pixels transitioning from the 47th gradation level to the 0th gradation level, the data having been obtained by correcting the gradation data T0 for the 0th gradation level.

In this case, an amount of change toward the low luminance side is removed as in FIG. 11, and an amount of change toward the high luminance side is further reduced compared with FIG. 12, specifically, to 34%. However, in the visual examination of the display quality, the flashing is not improved. In particular, visually detected is that a white screen appears to be inserted in the transition. Accordingly, the result is determined to be poor.

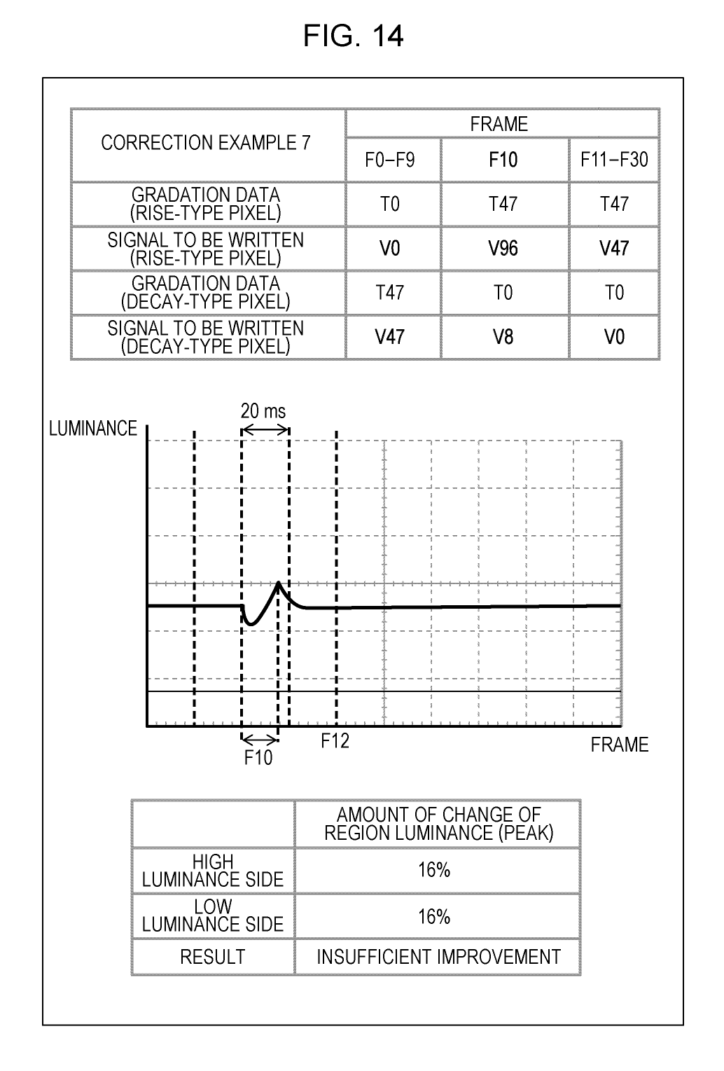

FIG. 14 illustrates a case that satisfies the following in FIG. 7(c): n=8 (with correction); m=96 (with correction); the signal V96 corresponding to data for a 96th gradation level is written to the rise-type pixels transitioning from the 0th gradation level to the 47th gradation level, the data having been obtained by correcting the gradation data T47 for the 47th gradation level; and the signal V8 corresponding to data for a 8th gradation level is written to the decay-type pixels transitioning from the 47th gradation level to the 0th gradation level, the data having been obtained by correcting the gradation data T0 for the 0th gradation level.

In this case, an amount of change toward the low luminance side is 16%. An amount of change toward the high luminance side is 16%; the amount of change toward the high luminance side is further reduced. In the visual examination of the display quality, a tendency toward an improvement is observed with respect to a point that there is visually detected that a white screen appears to be inserted in the transition, but the improvement is not sufficient.

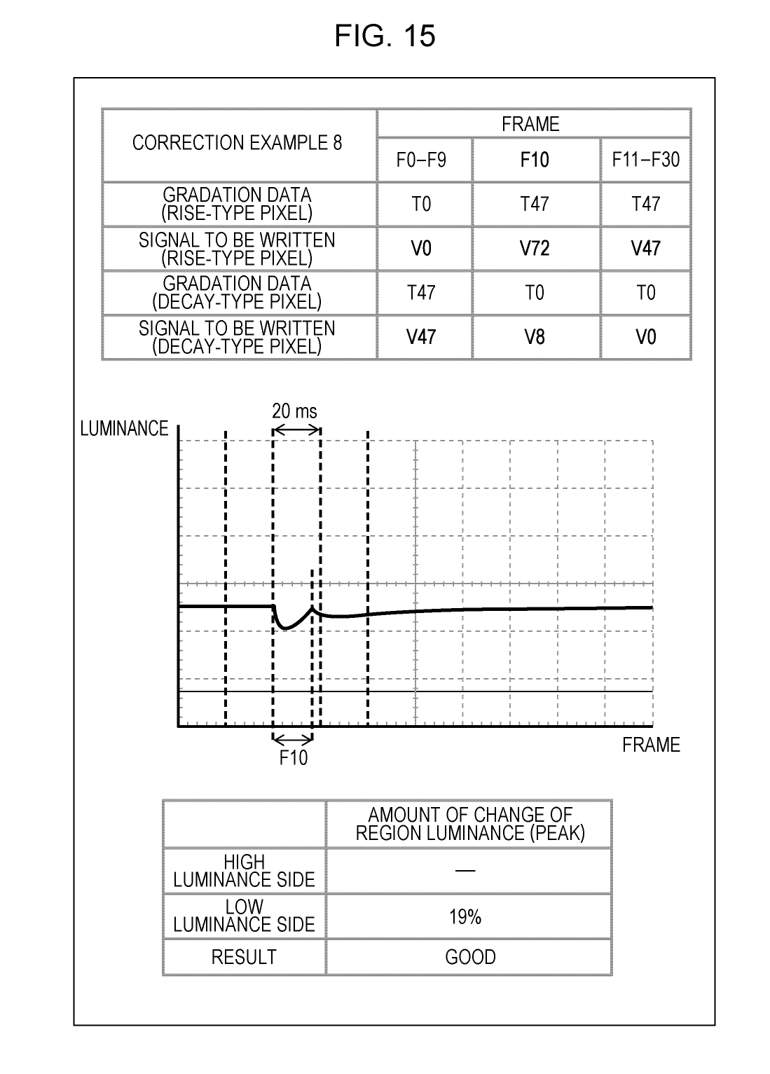

FIG. 15 illustrates a case that satisfies the following in FIG. 7(c): n=8 (with correction); m=72 (with correction); the signal V72 corresponding to data for a 72nd gradation level is written to the rise-type pixels transitioning from the 0th gradation level to the 47th gradation level, the data having been obtained by correcting the gradation data T47 for the 47th gradation level; and the signal V8 corresponding to data for a 8th gradation level is written to the decay-type pixels transitioning from the 47th gradation level to the 0th gradation level, the data having been obtained by correcting the gradation data T0 for the 0th gradation level.

In this case, because the adjustments to the rates of luminance change are appropriate, an amount of change toward the low luminance side is 19% and, also in the visual examination of the display quality, the flashing is sufficiently improved. Accordingly, the result is determined to be good. In this correction, a peak toward the high luminance side is observed in the transition, but a fact that the value thereof does not exceed the region luminance obtained before or after the transition (the region luminance reference value) is a specific feature. In a case where the peak toward the high luminance side is present in the transition, the fact that a white screen appears to be inserted is visually detected in the visual examination of the display quality. However, if the value thereof decreases (for example, an amount of change toward the high luminance side is equal to or smaller than 16%), visual detectability becomes low. In a case in particular where the value thereof does not exceed the region luminance reference value, insertion of the white screen is not visually detected. The result is therefore highly good. In addition, a change toward the low luminance side in the transition is less visually detectable than a change toward the high luminance side. Accordingly, even though the amount of change toward the low luminance side is larger than the amount of change toward the high luminance side, sufficient improvement effects can be obtained in some cases.

As described above, it is able to obtain appropriate corrections based on a combination of two gradation levels (the gradation transition) and to set the LUT. The control circuit 5 is able to generate writing gradation data on the basis of the LUT and a combination of the preceding gradation level and the current gradation level.

It should be noted that because an evaluation using a reversal of the checkered pattern illustrated in FIG. 7 corresponds to the worst case of the flashing, gradation corrections may be determined in accordance with display in actual use (for example, display where a white line moves on a black screen and that includes a small number of gradation transitions) so that a desired level of the flashing can be achieved.

It should be noted that because a period in which data obtained by correcting gradation data is written is a single frame (F10), the period is sufficiently short compared with response speeds of liquid crystals. Accordingly, effects on display itself may almost be ignored.

Because the LUT is determined in advance, necessary functions to be added to reduce the flashing are minimized. In addition, because a corrected gradation level can be generated by only comparing gradation levels of two frames, a required capacity of a memory can be made small.

The mode of the liquid crystal panel is not limited to a VA (vertical alignment) mode, and the present invention is suitable also for a TN mode and a lateral electric field mode. Note that because dependency of a response speed on a gradation level significantly depends on the liquid crystal mode, it is preferable to evaluate the corrected gradation levels individually.

The liquid crystal display device described above is able to efficiently reduce the flashing, which is likely to occur when an object having a high luminance is displayed on a background having a low luminance. Accordingly, the liquid crystal display device is suitable for displays for displaying CAD images, the displays displaying wire frames, and for displays for displaying maps, charts of routes, radar images, or fish finder images.

### CONCLUSION

A liquid crystal display device according to the present invention includes a first pixel and a second pixel. With respect to each of the first pixel and the second pixel, a first luminance corresponding to a first gradation level is lower than a second luminance corresponding to a second gradation level. The liquid crystal display device is characterized in that, in a case where the first pixel receives, in a preceding frame, first gradation data corresponding to the first gradation level, while receiving, in a current frame, second gradation data corresponding to the second gradation level, and where the second pixel receives, in the preceding frame, the second gradation data corresponding to the second gradation level, while receiving, in the current frame, the first gradation data corresponding to the first gradation level, at least one of writing a signal corresponding to data obtained by correcting the second gradation data to the first pixel and writing a signal corresponding to data obtained by correcting the first gradation data to the second pixel is performed in the current frame such that an amount of change of a summed luminance representing a sum of a luminance of the first pixel and a luminance of the second pixel toward a high luminance side relative to a sum of the first luminance and the second luminance is smaller than an amount of change of the summed luminance toward a low luminance side relative to the sum of the first luminance and the second luminance.

The liquid crystal display device may be configured such that, with respect to each of the first pixel and the second pixel, in the current frame in which gradation data identical to gradation data of the preceding frame is input, writing a signal corresponding to the gradation data of the current frame is performed.

The liquid crystal display device may be configured such that the amount of change of the summed luminance toward the low luminance side is smaller than 30% of the sum of the first luminance and the second luminance and the amount of change of the summed luminance toward the high luminance side is smaller than 15% of the sum of the first luminance and the second luminance.

The liquid crystal display device may be configured such that, in the case described above, a signal corresponding to data that is corrected so as to increase a rate of luminance change is written to one of the first and second pixels and a signal corresponding to data that is corrected so as to decrease the rate of luminance change is written to the other of the first and second pixels.

The liquid crystal display device may be configured such that the amount of change of the summed luminance toward the high luminance side is zero.

The liquid crystal display device may be configured so as to determine a combination of two different gradation levels such that a difference between a response time defined in a case where a luminance is caused to rise from a luminance corresponding to one of the two different gradation levels to a luminance corresponding to the other of the two different gradation levels and a response time defined in a case where the luminance is caused to decay from the luminance corresponding to the other of the two different gradation levels to the luminance corresponding to the one of the two different gradation levels is equal to or larger than a threshold value, and so as to make the two gradation levels to correspond to the first and second gradation levels.

The liquid crystal display device may be configured such that, in a case where a gradation region ranging from a minimum gradation level to a maximum gradation level is divided into three regions of a low gradation region, a medium gradation region, and a high gradation region, the combination of the two gradation levels includes a combination of the minimum gradation level and a gradation level that is included in the medium gradation region.

The liquid crystal display device may be configured so as to further include a vertically aligned liquid crystal layer.

The liquid crystal display device may be configured such that the first and second pixels are pixels of an identical color.

A method for driving a liquid crystal panel according to the present invention is a driving method of a liquid crystal panel including a first pixel and a second pixel, in which, with respect to each of the first pixel and the second pixel, a first luminance corresponding to a first gradation level is lower than a second luminance corresponding to a second gradation level. The method is characterized in that, in a case where the first pixel receives, in a preceding frame, first gradation data corresponding to the first gradation level, while receiving, in a current frame, second gradation data corresponding to the second gradation level, and where the second pixel receives, in the preceding frame, the second gradation data corresponding to the second gradation level, while receiving, in the current frame, the first gradation data corresponding to the first gradation level, at least one of writing a signal corresponding to data obtained by correcting the second gradation data to the first pixel and writing a signal corresponding to data obtained by correcting the first gradation data to the second pixel is performed in the current frame, such that an amount of change of a summed luminance representing a sum of a luminance of the first pixel and a luminance of the second pixel toward a high luminance side relative to a sum of the first luminance and the second luminance is smaller than an amount of change of the summed luminance toward a low luminance side relative to the sum of the first luminance and the second luminance.

A method for setting a signal to be written in a liquid crystal display device according to the present invention is characterized in the following: repeatedly performing a process that, in a first period, displays a first checkered pattern including both a plurality of first regions, each including a pixel to which a first gradation signal corresponding to a first gradation level is written, and a plurality of second regions, each including a pixel to which a second gradation signal corresponding to a second gradation level is written, and that, in a subsequent second period, displays a second checkered pattern by writing the second gradation signal to the pixel included in the first regions and by writing the first gradation signal to the pixel included in the second regions; measuring the amount of luminance change in a display area for the first and second checkered patterns; and for a combination of first and second gradation levels which causes the amount of luminance change to be equal to or larger than a reference value, performing at least one of: writing to a pixel to which first gradation data corresponding to the first gradation level is input in a preceding frame and to which second gradation data corresponding to the second gradation level is input in a current frame a signal corresponding to data obtained by correcting the second gradation data; and writing to a pixel to which the second gradation data corresponding to the second gradation level is input in the preceding frame and to which the first gradation data corresponding to the first gradation level is input in the current frame a signal corresponding to data obtained by correcting the first gradation data.

The method for setting a signal to be written in a liquid crystal display device may be a method in which each of the first and second regions is composed of a single pixel as a unit.

The method for setting a signal to be written in a liquid crystal display device may be a method in which each of the first and second regions is composed of a single picture element as a unit, the single picture element including three or more pixels that are different in color from one another.

The method for setting a signal to be written in a liquid crystal display device may be a method in which the corrected data is determined such that writing the signal, in a period including the first and second periods, to a pixel that is included in at least one of the first and second regions causes the amount of luminance change to be smaller than the reference value.

The invention should not be limited to the embodiments described above, and embodiments obtained by combining technical means as appropriate that are disclosed in respective embodiments different from one another are covered by the scope of the invention. In addition, it is possible to develop new technical features by combining technical means each of which is disclosed in a corresponding embodiment.

### REFERENCE SIGNS LIST

3 Liquid crystal display device
4 Liquid crystal panel
5 Control circuit
6 Gate driver
7 Source driver
8 Backlight
T0 Gradation data for 0th gradation level (first gradation data)
T47 Gradation data for 47th gradation level (second gradation data)
V0 signal to be written that corresponds to gradation data for 0th gradation level
V47 signal to be written that corresponds to gradation data for 47th gradation level

1. A liquid crystal display device comprising:
a first pixel; and
a second pixel,
wherein, with respect to each of the first pixel and the second pixel, a first luminance corresponding to a first gradation level is lower than a second luminance corresponding to a second gradation level, and
wherein, in a case where the first pixel receives, in a preceding frame, first gradation data corresponding to the first gradation level, while receiving, in a current frame, second gradation data corresponding to the second gradation level, and the second pixel receives, in the preceding frame, the second gradation data corresponding to the second gradation level, while receiving, in the current frame, the first gradation data corresponding to the first gradation level,
at least one of writing a signal corresponding to data obtained by correcting the second gradation data to the first pixel and writing a signal corresponding to data obtained by correcting the first gradation data to the second pixel is performed in the current frame such that an amount of change of a summed luminance representing a sum of a luminance of the first pixel and a luminance of the second pixel toward a high luminance side relative to a sum of the first luminance and the second luminance is smaller than an amount of change of the summed luminance toward a low luminance side relative to the sum of the first luminance and the second luminance.

2. The liquid crystal display device according to claim 1,
wherein, with respect to each of the first pixel and the second pixel, in the current frame in which gradation data identical to gradation data of the preceding frame is input, writing a signal corresponding to the gradation data of the current frame is performed.

3. The liquid crystal display device according to claim 1,
wherein the amount of change of the summed luminance toward the low luminance side is smaller than 30% of the sum of the first luminance and the second luminance, and the amount of change of the summed luminance toward the high luminance side is smaller than 15% of the sum of the first luminance and the second luminance.

4. The liquid crystal display device according to claim 1,
wherein, in the case according to claim 1, a signal corresponding to data that is corrected so as to increase a rate of luminance change is written to one of the first and second pixels and a signal corresponding to data that is corrected so as to decrease the rate of luminance change is written to the other of the first and second pixels.

5. The liquid crystal display device according to claim 1,
wherein the amount of change of the summed luminance toward the high luminance side is zero.

6. The liquid crystal display device according to claim 1,
wherein a combination of two different gradation levels is determined such that a difference between a response time defined in a case where a luminance is caused to rise from a luminance corresponding to one of the two different gradation levels to a luminance corresponding to the other of the two different gradation levels and a response time defined in a case where the luminance is caused to decay from the luminance corresponding to the other of the two different gradation levels to the luminance corresponding to the one of the two different gradation levels is equal to or larger than a threshold value, and
wherein the two gradation levels are made to correspond to the first and second gradation levels.

7. The liquid crystal display device according to claim 6,
wherein, in a case where a gradation region ranging from a minimum gradation level to a maximum gradation level is divided into three regions of a low gradation region, a medium gradation region, and a high gradation region, the combination of the two gradation levels includes a combination of the minimum gradation level and a gradation level that is included in the medium gradation region.

8. The liquid crystal display device according to claim 7 further comprising
a vertically aligned liquid crystal layer.

9. The liquid crystal display device according to claim 1,
wherein the first and second pixels are pixels of an identical color.

10. A method for driving a liquid crystal panel including a first pixel and a second pixel, in which, with respect to each of the first pixel and the second pixel, a first luminance corresponding to a first gradation level is lower than a second luminance corresponding to a second gradation level, the method comprising
in a case where the first pixel receives, in a preceding frame, first gradation data corresponding to the first gradation level, while receiving, in a current frame, second gradation data corresponding to the second gradation level, and the second pixel receives, in the preceding frame, the second gradation data corresponding to the second gradation level, while receiving, in the current frame, the first gradation data corresponding to the first gradation level,
performing, in the current frame, at least one of writing a signal corresponding to data obtained by correcting the second gradation data to the first pixel and writing a signal corresponding to data obtained by correcting the first gradation data to the second pixel, such that an amount of change of a summed luminance representing a sum of a luminance of the first pixel and a luminance of the second pixel toward a high luminance side relative to a sum of the first luminance and the second luminance is smaller than an amount of change of the summed luminance toward a low luminance side relative to the sum of the first luminance and the second luminance.

11. A method for setting a signal to be written in a liquid crystal display device, the method comprising:
repeatedly performing a process that, in a first period, displays a first checkered pattern including both a plurality of first regions, each including a pixel to which a first gradation signal corresponding to a first gradation level is written, and a plurality of second regions, each including a pixel to which a second gradation signal corresponding to a second gradation level is written, and that, in a subsequent second period, displays a second checkered pattern by writing the second gradation signal to the pixel included in the first regions and by writing the first gradation signal to the pixel included in the second regions, and measuring an amount of luminance change in a display area for the first and second checkered patterns; and
for a combination of first and second gradation levels which causes the amount of luminance change to be equal to or larger than a reference value, performing at least one of: writing to a pixel to which first gradation data corresponding to the first gradation level is input in a preceding frame and to which second gradation data corresponding to the second gradation level is input in a current frame a signal corresponding to data obtained by correcting the second gradation data;
and writing to a pixel to which the second gradation data corresponding to the second gradation level is input in the preceding frame and to which the first gradation data corresponding to the first gradation level is input in the current frame a signal corresponding to data obtained by correcting the first gradation data.

12. The method for setting a signal to be written in a liquid crystal display device according to claim 11,
wherein each of the first and second regions is composed of a single pixel as a unit.

13. The method for setting a signal to be written in a liquid crystal display device according to claim 11,
wherein each of the first and second regions is composed of a single picture element as a unit, the single picture element including three or more pixels that are different in color from one another.

14. The method for setting a signal to be written in a liquid crystal display device according to claim 11,
wherein the corrected data is determined such that writing the signal, in a period including the first and second periods, to a pixel that is included in at least one of the first and second regions causes the amount of luminance change to be smaller than the reference value.
